(19) United States
(12) Patent Application Publication
(10) Pub. No.: US 2014/0176992 A1
(43) Pub. Date: Jun. 26, 2014

(54) METHOD AND SYSTEM FOR IMPLEMENTING PRINTING SERVICE

(71) Applicants: BEIJING FOUNDER ELECTRONICS CO., LTD., Beijing (CN); PEKING UNIVERSITY FOUNDER GROUP CO., LTD., Beijing (CN)

(72) Inventors: Shaokun SHI, Beijing (CN); Qianqian XIE, Beijing (CN); Hao XIE, Beijing (CN)

(73) Assignees: BEIJING FOUNDER ELECTRONICS CO., LTD., Beijing (CN); PEKING UNIVERSITY FOUNDER GROUP CO., LTD., Beijing (CN)

(21) Appl. No.: 14/090,575

(22) Filed: Nov. 26, 2013

(30) Foreign Application Priority Data
Dec. 24, 2012 (CN) 201210567699.0

(51) Int. Cl. G06F 3/12

(52) U.S. Cl. CPC G06F 3/1206; G06F 3/1288; G06F 3/1226
USPC 358/1.15

(57) ABSTRACT

Embodiments of the present invention provide a system for implementing a printing service, comprising: a user terminal, a cloud printing service platform in a cloud, and a plurality of printing service provider terminals; wherein the cloud printing service platform comprises: a receiving module, configured to receive over the cloud a file from the user terminal, and a selection of the plurality of printing service provider terminals; a converting module, configured to convert the file into a file in a uniform format; and a sending module, configured to send the file in the uniform format to the selected printing service provider terminal for printing.

### BACKGROUND OF THE INVENTION

1. Field of the Invention

Embodiments of the present invention relate to the field of printing, and in particular, to a method and system for implementing a printing service.

2. Description of the Prior Art

In the prior art, to deal with large amounts of emergency printing, a large number of printing terminals are aggregated to form a printing center that is characterized as having great throughput and strong printing capabilities.

However, in most cases, users desire anytime and anywhere printing capabilities. Although the traditional printing center has strong printing capabilities, in consideration of costs, the printing centers may be deployed at a limited number of geographical locations. Before users select printers for printing or press tasks, distance is an important factor to be considered first. Therefore, printing capabilities of the traditional printing center have not yet fully utilized, which fails to accommodate users' anytime and anywhere printing requirements.

### SUMMARY OF THE INVENTION

In view of the above problem, embodiments of the present invention are directed to providing a method and system for implementing a printing service.

An embodiment of the present invention provides a system for implementing a printing service, comprising: a user terminal, a cloud printing service platform in a cloud, and a plurality of printing service provider terminals; wherein the cloud printing service platform comprises: a receiving module, configured to receive over the cloud a file and a selection of a printing service provider terminal from the user terminal; a converting module, configured to convert the file into a file in a uniform format; and a sending module, configured to send the file in the uniform format to the selected printing service provider terminal for printing.

Another embodiment of the present invention provides a method for implementing a printing service, comprising: receiving, by a cloud printing service platform in a cloud, a file and a selection of a printing service provider terminal in the cloud from a user terminal; converting the file into a file in a uniform format; and sending the file in the uniform format to the selected printing service provider terminal for printing.

Another embodiment of the present invention provides a non-transient storage media storing a program for performing a method for implementing a printing service, so as to cause a computer to enable the program stored in the non-transient storage media to carry out the above mentioned method.

The method and system for implementing a printing service implements cloud-based printing, which enables a user to implement printing by using a printer at his or her side by means of various devices anytime and anywhere. In this way, user's printing is not limited to specific regions and devices, and the user may print materials as required, on a business trip, at a remote office, over a smart phone, over a tablet computer and so on.

### BRIEF DESCRIPTION OF THE DRAWINGS

The accompanying drawings herein, which are incorporated herein and constitute a part of the specification, illustrate several exemplary embodiments of the present invention and together with the description, serve to illustrate the embodiments of the present invention, construing no limitation to the present invention. In the drawings:

FIG. 1 is a schematic view of a system for implementing a printing service according to an embodiment of the present invention;

FIG. 2 is a schematic view of a cloud-based printing service platform according to an embodiment of the present invention;

FIG. 3 is a schematic view of a user terminal according to an embodiment of the present invention;

FIG. 4 is a flowchart of a method for implementing a printing service according to an embodiment of the present invention;

FIG. 5 is a schematic view of a system for implementing a printing service according to a preferred embodiment of the present invention;

FIG. 6 is a screenshot of a printer management function provided by a printing service provider terminal according to a preferred embodiment of the present invention;

FIG. 7 is a screenshot of a specific process for setting up a printer of the user terminal and searching for the printer according to a preferred embodiment of the present invention; and

FIG. 8 is a screenshot of a specific process for registering printing capabilities of a printing service provide terminal according to a preferred embodiment of the present invention.

### DETAILED DESCRIPTION OF THE PREFERRED EMBODIMENTS

The present invention is described in detail with reference to attached drawings and exemplary embodiments.

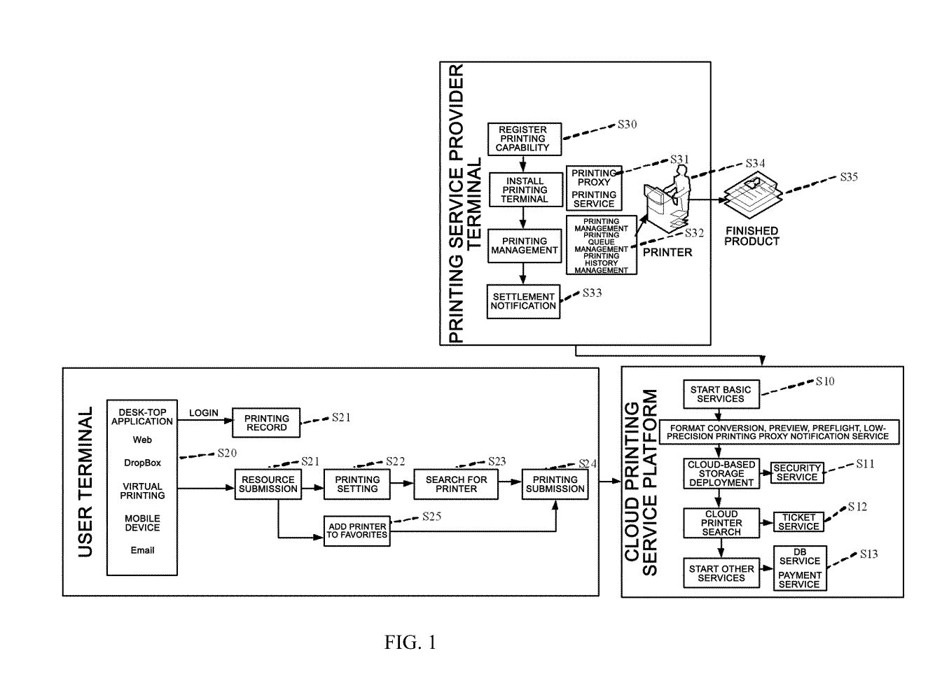

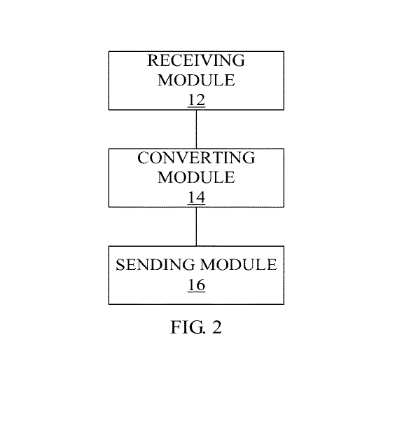

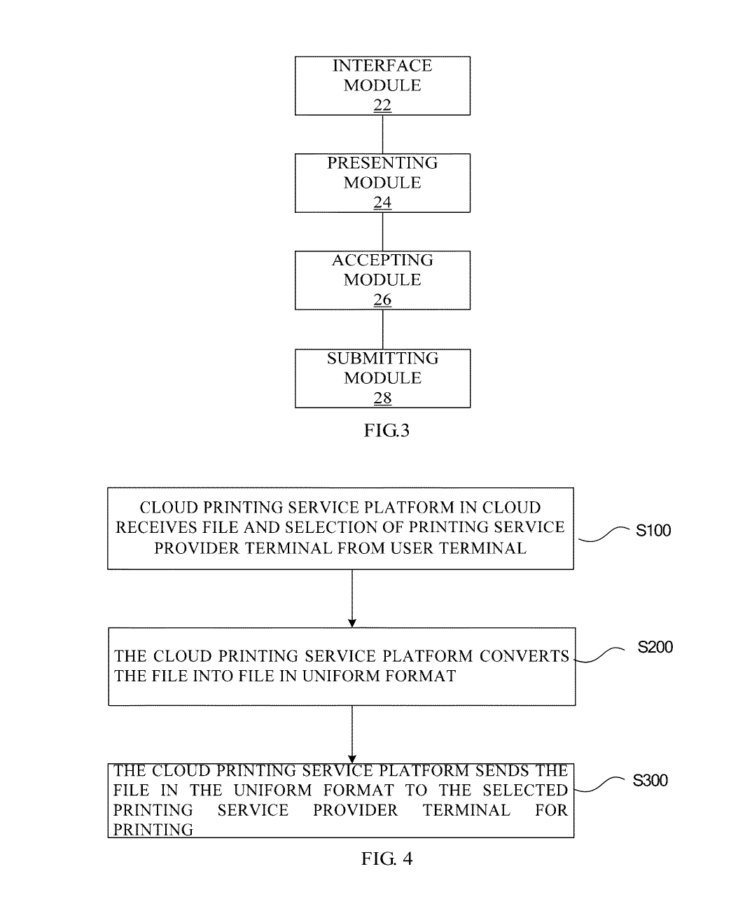

FIG. 1 is a schematic view of a system for implementing a printing service according to an embodiment of the present invention; and FIG. 2 is a schematic view of a cloud-based printing service platform according to an embodiment of the present invention. The system for implementing a printing service comprises a cloud printing service platform in a cloud; wherein the cloud printing service platform comprises: a receiving module 12, configured to receive over the cloud a file and a selection of a printing service provider terminal from a user terminal; a converting module 14, configured to convert the file into a file in a uniform format; and a sending module 16, configured to send the file in the uniform format to the selected printing service provider terminal for printing. Furthermore, the system may further comprise a user terminal, configured to send over the cloud the file and the selection of a printing service provider terminal to the cloud printing service platform. Furthermore, the system may further comprise a plurality of printing service provider terminals, configured to print the file in the uniform format.

The cloud-based printing may establish a printing application, which allows any devices to directly print materials by using any printer anywhere in the world without considering the application program (regardless of a local desk-top program, a mobile program, or a network program) and the printer driver program. In this way, any document may be printed by using any printer anytime and anywhere.

The system implements a cloud-based printing, which enables a user to implement printing by using a printer at his or her side by means of various devices anytime and anywhere. In this way, user's printing is not limited to specific regions and devices, and the user may print materials as required, on a business trip, at a remote office, over a smart phone, over a tablet computer and so on.

Preferably, the cloud printing service platform may further comprise a registration module, configured to register geographical locations, prices, and printer capability descriptions of the plurality of printing service provider terminals to the cloud printing service platform.

The printing service provider terminal may provide a printer management function (management of printer status, printer queue, printer's printer capability description, scheduling on files to be printed, and the like). After printing terminal software is installed, the extraction service and the printing service are started for the files to be printed locally; wherein the extraction service is responsible for extracting from a cloud end a printing task submitted by the user to the printing terminal, while the printing service is responsible for completing a practical printing task according to scheduling of a printer schedule queue after the printing task is extracted.

Preferably, the cloud printing service platform may comprise: a searching module, configured to search for the geographical locations, the prices, and the printer capability descriptions of the plurality of printing service provider terminals according to search conditions defined by the user terminal; and a feedback module, configured to send search results to the user terminal. The user terminal may comprise: an interface module 22, configured to provide a search interface and accept the search conditions input by a user via the search interface; a presenting module 24, configured to present the search results; an accepting module 26, configured to accept one of the plurality of printing service provider terminals that is selected by the user from the search results; and a submitting module 28, configured to submit the selected printing service provider terminal and the file to the cloud printing service platform.

Filtering may be implemented by searching. The user may filter the printing service provider terminals according a plurality of conditions such as his or her desired region and expected price. After the filtering, the cloud end may organize, according to the user's selection, the user's search conditions and requirements into a ticket file that may be recognized by the cloud end, and submit the ticket file and the file to be printed to the cloud printing service platform.

Preferably, the printing service provider terminal may be further configured to provide a settlement price for the printing.

The cloud printing service platform may submit, according to settings made by the user, the file to be printed to the selected printing service provider terminal for queuing or instant processing. The cloud printing service platform may further provide a cloud-based storage service and a management service for files to be printed. The cloud printing service platform may still further provide a security service for safeguarding security of electronic files and implementing a cloud printer search function.

A function of searching for a suitable printer according to such information as geographical locations and printer capability description may be combined with location information for searching for a closest printing service provider with respect to a mobile Internet user.

FIG. 4 is a flowchart of a method for implementing a printing service according to an embodiment of the present invention, comprising the following steps:

Step S100: A cloud printing service platform in cloud receives a file and a selection of a printing service provider terminal from a user terminal.

Step S200: The cloud printing service platform converts the file into a file in a uniform format.

Step S300: The cloud printing service platform sends the file in the uniform format to the selected printing service provider terminal for printing.

The method implements a cloud-based printing, which enables a user to implement printing by using a printer at his or her side by means of various devices anytime and anywhere. In this way, user's printing is not limited to specific regions and devices, and the user may print materials as required, on a business trip, at a remote office, over a smart phone, over a tablet computer and so on.

Preferably, the method may further comprise: registering geographical locations, prices, and printer capability descriptions of the plurality of printing service provider terminals to the cloud printing service platform in advance.

Preferably, the method may further comprise: providing, by the user terminal, a search interface, and accepting search conditions inputted by a user; searching for, by the cloud printing service platform, the geographical locations, the prices, and the printer capability descriptions of the plurality of printing service provider terminals according to the search conditions; sending search results to the user terminal; presenting, by the user terminal, the search results; accepting, by the user terminal, one of the plurality of printing service provider terminals that is selected by the user from the search results; and submitting, by the user terminal, the selected printing service provider terminal and the file to the cloud printing service platform.

Preferably, the user terminal sends the selected printing service provider terminal and the file to the cloud printing service platform by using a mobile applications, a Web application, a PC virtual printer driver, a network file synchronization application, or a desk-top application. The mobile application may refer to file submission by means of an iPad; the Web application may refer to file submission over a web page; the PC virtual printer driver may refer to direct file submission by using a virtual printer driver on a PC terminal; the network file synchronization application, for example Dropbox, may refer to submission by using Dropbox.

Preferably, the method may further comprise: printing, by the printing service provider terminal, the file in the uniform format, and providing a settlement price for the printing.

Preferably, the method may further comprise: generating, by the cloud printing service platform, a printing preview for the file; and sending the printing preview to the user terminal.

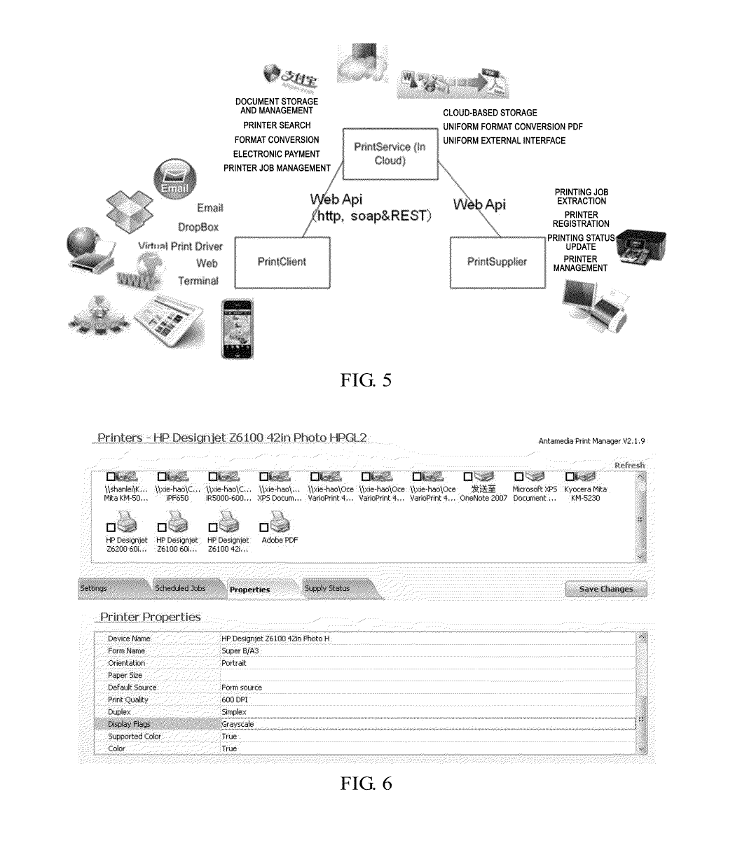

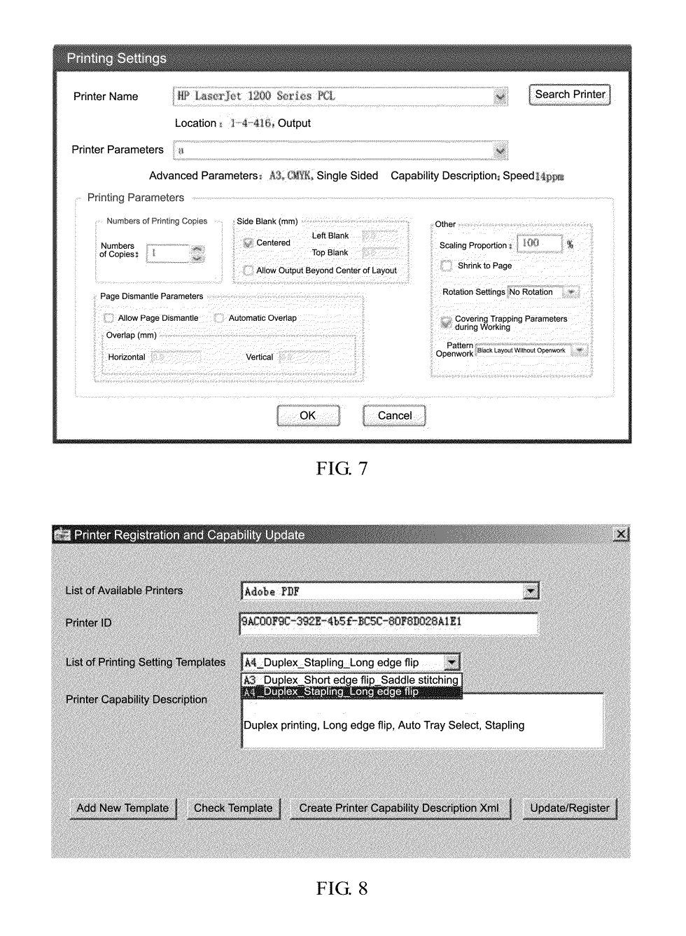

FIG. 5 is a schematic view of a system for implementing a printing service according to a preferred embodiment of the present invention; FIG. 6 is a screenshot for a printer management function provided by a printing service provider terminal according to a preferred embodiment of the present invention; FIG. 7 is a screenshot for a specific process for setting up a printer of the user terminal and searching for the printer according to a preferred embodiment of the present invention; and FIG. 8 is a screenshot for a specific process for registering printing capabilities of the printing service provide terminal according to a preferred embodiment of the present invention. Here, PrintClient is the user terminal; PrintService is the cloud printing service platform; while PrintSupplier is the printing service provider terminal.

As illustrated in FIG. 1, the method may comprise the following steps:

(1) The cloud printing service platform performs S10 to start basic services, publishes basic services such as uniformly converting files submitted by users into PDF files or files in other formats in the cloud, and generating previews thereof, starts a printing proxy service for sorting and submitting to-be-printed files submitted by the users to each of the printing terminals, starts a feedback notification service for providing a reminder service for the user terminal after the printing terminals complete printing, such that the user terminal is timely notified for the printed materials and fee payment after the printing tasks are completed by the printing service provider terminals.

The basic services may further comprise other supported service forms, such as preflight service, preview service, decryption service, low-precision PDF generation service, printing service and so on. The traditional press or printing service provider provides a large number of basic technical services, such as PDF generation service, preflight service, format conversion service, preview service, decryption service, low-precision PDF generation service, and printing services and so on. These basic services are currently used for invocation in a form of within enterprises or encapsulation invocation in simple forms, and therefore the advantages of these services fail to be brought into full play. According to the preferred embodiments of the present invention, these services may be widely used.

(2) The cloud printing service platform performs S11 to deploy the cloud-based storage service and the management service of files to be printed, and the security service for safeguarding security of the electronic files of the users; wherein the users' files stored by using the cloud-based storage service may be stored in a directory which is created by integrally considering user information and information of the selected printing service provider terminal. This helps the printing service provider terminal to extract files and helps the user terminal to collect statistics thereof.

(3) The cloud printing service platform performs S13 to start a database (DB) service for querying printing records of the printer, and storing uploaded resource file records, and other record information that needs to be stored in a database, and start a payment service for paying for online transactions, including encapsulation of netbank payment methods such as Alipay and 99Bill for completing transactions of two parties.

(4) The cloud printing service platform performs S12 to provide a cloud-based printer search function. Using this function, a user may search for a suitable printing service provider terminal according to user's selected search conditions such as geographical location and printer capability description. In addition, the platform further starts a ticket service to convert the selected search conditions into a ticket file, and the ticket file and the resource files are to be extracted by the printing service provider terminal.

(5) The user terminal performs S20 and S21, and the user logs in to a cloud printing service website over a mobile application, a Web application, a PC virtual printer driver, Dropbox, a desk-top application and so on, and submits the files to be printed to the cloud.

(6) The user terminal performs S22 for printing settings. As illustrated in FIG. 7, the specific process is as follows: The user filters, according to a plurality of conditions such as his or her desired region and expected price, the printing service provider terminals by using a printer search system provided at the cloud end; and after the filtering, the cloud end may organize, according to the user's selection, the user's search conditions and requirements into a ticket file that may be recognized by the cloud end.

(7) The user terminal performs S23, that after the printing service provider terminal registers the cloud-based printers, information of the cloud-end printers is recorded in the cloud platform, including basic information and basic properties (single-face, color) of the printer. Since advanced properties of each printer are different, description of the advanced properties of the printer may not be selected, but is subject to text form. These selection conditions are submitted to the cloud platform to generate a recognizable ticket file as an input condition for the printing service provider terminal to perform printing.

(8) After performing S23, the user terminal may also save the printing condition as a common search condition, and add the printer to Favorites. In case of a subsequent printing task, the user terminal does not need to repeat the selection, but directly uses the added printer to perform quick printing and submission.

(9) After foreground printing terminal software is installed, the user terminal may convert files in such common file formats (html, doc, ps, and txt) by using the installed virtual printer driver, and upload the converted files to the cloud end.

(10) The printing service provider terminal performs S30 to register the printing capabilities to the cloud printing service platform for the user to search. The specific process may be as illustrated in FIG. 8. Complicated advanced properties may be described by using the Devmode structure parameter of the printer, and the printing capabilities of the printer may be registered to a remote end by clicking the registration button.

During registration of the printing capability of the printing service provider terminal, description of the basic printing parameters of the printer may be directly selected, and the advanced printing parameters may be described in text. During submission, a registration printer tool may convert the user's description text into an xml file for describing the printing capabilities of the printer.

(11) The printing service provider terminal performs S31, after the printing terminal software has been installed, to locally start the extraction service and the printing service for the files to be printed; wherein the extraction service is responsible for extracting from a cloud end a printing task submitted by the user to the printing terminal, while the printing service is responsible for completing a practical printing task according to scheduling of a printer schedule queue after the printing task is extracted.

Preferably, during file extraction, the printing service provider terminal needs to provide, after interconnecting with the cloud printing service platform, a unique identity for identification of the terminal, which prevents theft on files of other terminals.

Preferably, each of the printers of the printing service provider terminal, only with granted permission, may use and provide a review function for the printing tasks. These tasks may be printed only after the review is successfully performed.

After a printing terminal is installed on the printing service provider terminal, the printing service started locally may start a Raster Image Processor (RIP) module for rasterizing the files to be printed. After the rasterizing, the printing scheduling service is started to perform the printing tasks.

(12) The printing service provider terminal performs S32 to provide the printer management function (management of printer status, printer queue, printer's printer capability description, scheduling on files to be printed, and the like), the specific implementation of which is as illustrated in FIG. 6. In addition, with respect to the printer end, the printing service provider terminal further provides such services as printing management, statistical collection, analysis, transaction settlement, and printer status update.

(13) The printing service provider terminal performs S33 to provide a notification service upon completion of the printing tasks. After the printing tasks are completed, the cloud printing service platform is notified to update printing progress of the resources and indicate idle status of the printer.

The cloud printing service platform may further provide a reminder service for the user terminal, such that the user terminal is timely notified for the printed materials and fee payment after the printing tasks are completed by the printing service provider terminals.

The user terminal may register to and log in to the cloud printing service platform, check submission history of personal files and processing progress of the current file, and export the printing record.

After login-in, the user terminal may add the search conditions thereof to Favorites, and may directly select a printer according to the added search conditions to perform quick printing and submission.

Using cloud-based printing, printer manufacturers may convert products into services, and improve customer satisfactory and support by means of customized and differentiated derivative services, thereby acquiring more competitiveness.

It is apparent that a person skilled in the art should understand that the above-described module or steps according to the embodiments of the present invention may be implemented through a universal computing device. These modules or steps may be integrated on one computing device or arranged on the network formed by a plurality of computing device. Optionally, the modules or steps may be implemented through executable program code stored on the computing device. In this way, the modules or steps may be stored in a storage apparatus and implemented by the computing device. Alternatively, the modules or steps may be implemented into integrated circuit modules or multiple modules or steps thereof may be implemented into an individual integrated circuit module. In this way, the present invention is not subject to limitation of any specific combination of hardware and software.

Described above are merely preferred embodiments of the present invention, but are not intended to limit the present invention. A person skilled in the art may derive various modifications and variations. Any modification, equivalent replacement, or improvement made without departing from the spirit and principle of the present invention should fall within the protection scope of the present invention.

What is claimed is:

1. A system for implementing a printing service, comprising: a cloud printing service platform in a cloud; wherein
the cloud printing service platform comprises: a receiving module, configured to receive over the cloud a file and a selection of a printing service provider terminal from a user terminal; a converting module, configured to convert the file into a file in a uniform format; and a sending module, configured to send the file in the uniform format to the selected printing service provider terminal for printing.

2. The system according to claim 1, further comprising a user terminal, configured to send over the cloud the file and the selection of a printing service provider terminal to the cloud printing service platform.

3. The system according to claim 1, further comprising: a plurality of printing service provider terminals, configured to print the file in the uniform format.

4. The system according to claim 1, wherein the cloud printing service platform further comprises:
a registration module, configured to register geographical locations, prices, and printer capability descriptions of a plurality of printing service provider terminals to the cloud printing service platform.

5. The system according to claim 4, wherein
the cloud printing service platform comprises: a searching module, configured to search for the geographical locations, the prices, and the printer capability descriptions of the plurality of printing service provider terminals according to search conditions defined by the user terminal; and a feedback module, configured to send search results to the user terminal

6. The system according to claim 2, wherein
the user terminal comprises: an interface module, configured to provide a search interface, and accept the search conditions inputted by a user; an presenting module, configured to present the search results; an accepting module, configured to accept one of the plurality of printing service provider terminals that is selected by the user from the search results; and a submitting module, configured to submit the selected printing service provider terminal and the file to the cloud printing service platform.

7. The system according to claim 3, wherein the printing service provider terminal is further configured to provide a settlement price for the printing.

8. A method for implementing a printing service, comprising:
receiving, by a cloud printing service platform in a cloud, a file and a selection of a printing service provider terminal in the cloud from a user terminal;
converting the file into a file in a uniform format; and
sending the file in the uniform format to the selected printing service provider terminal for printing.

9. The method according to claim 8, further comprising:
registering geographical locations, prices, and printer capability descriptions of a plurality of printing service provider terminals to the cloud printing service platform in advance.

10. The method according to claim 9, further comprising:
providing, by the user terminal, a search interface, and accepting search conditions inputted by a user;
searching for, by the cloud printing service platform, the geographical locations, the prices, and the printer capability descriptions of the plurality of printing service provider terminals according to the search conditions;
sending search results to the user terminal;
presenting, by the user terminal, the search results;
accepting, by the user terminal, one of the plurality of printing service provider terminals that is selected by the user from the search results; and
submitting, by the user terminal, the selected printing service provider terminal and the file to the cloud printing service platform.

11. The method according to claim 10, wherein the user terminal sends the selected printing service provider terminal and the file to the cloud printing service platform by using a mobile applications, a Web application, a PC virtual printer driver, a network file synchronization application, or a desk-top application.

12. The method according to claim 8, further comprising:
printing, by the printing service provider terminal, the file in the uniform format, and providing a settlement price for the printing.

13. The method according to claim 8, further comprising:
generating, by the cloud printing service platform, a printing preview for the file; and
sending the printing preview to the user terminal

14. A non-transient storage media storing a program for performing a method for implementing a printing service, so as to cause a computer to enable the program stored in the non-transient storage media to carry out the following steps:
receiving, by a cloud printing service platform in a cloud, a file and a selection of a printing service provider terminal in the cloud from a user terminal;
converting the file into a file in a uniform format; and
sending the file in the uniform format to the selected printing service provider terminal for printing.

15. The non-transient storage media according to claim 14, further comprising:
registering geographical locations, prices, and printer capability descriptions of a plurality of printing service provider terminals to the cloud printing service platform in advance.

16. The non-transient storage media according to claim 15, further comprising:
providing, by the user terminal, a search interface, and accepting search conditions inputted by a user;
searching for, by the cloud printing service platform, the geographical locations, the prices, and the printer capability descriptions of the plurality of printing service provider terminals according to the search conditions;
sending search results to the user terminal;
presenting, by the user terminal, the search results;
accepting, by the user terminal, one of the plurality of printing service provider terminals that is selected by the user from the search results; and
submitting, by the user terminal, the selected printing service provider terminal and the file to the cloud printing service platform.

17. The non-transient storage media according to claim 16, wherein the user terminal sends the selected printing service provider terminal and the file to the cloud printing service platform by using a mobile applications, a Web application, a PC virtual printer driver, a network file synchronization application, or a desk-top application.

18. The non-transient storage media according to claim 14, further comprising:
printing, by the printing service provider terminal, the file in the uniform format, and providing a settlement price for the printing.

19. The non-transient storage media according to claim 14, further comprising:
generating, by the cloud printing service platform, a printing preview for the file; and
sending the printing preview to the user terminal
